(19) United States
(12) Patent Application Publication
(10) Pub. No.: US 2020/0062661 A1
(43) Pub. Date: Feb. 27, 2020

(54) CORE-HYDROPHOBIC THERMAL INSULATION SHEET HAVING HARDENED SURFACE

(71) Applicant: EVONIK DEGUSSA GMBH, Essen (DE)

(72) Inventors: Matthias Geisler, Nörten-Hardenberg (DE); Frank MENZEL, Hanau (DE)

(73) Assignee: EVONIK DEGUSSA GMBH, Essen (DE)

(21) Appl. No.: 16/605,342

(22) PCT Filed: May 8, 2018
(86) PCT No.: PCT/EP2018/061761

§ 371 Date: Oct. 15, 2019

(30) Foreign Application Priority Data
May 17, 2017 (EP) 17171533.7

(51) Int. Cl. C04B 41/00; C04B 41/52; E04B 1/80

(52) U.S. Cl. CPC C04B 41/009; C04B 2111/28; E04B 1/80; C04B 41/52

(57) ABSTRACT

Silicon dioxide-containing thermal-insulation sheet hydrophobized throughout with hardened surface, wherein the compressive stress at fracture measured on the sheet surface is higher than the compressive stress at fracture measured on the sectional surface in the middle cross section of the sheet parallel to the sheet surface, at, in each case, the same penetration depths of the measurement probe in the test specimen.

The invention relates to a new type of core-hydrophobic thermal-insulating sheet and to a process for the production thereof.

DE 3037409 A discloses making thermal-insulation materials composed of foamed perlites water-repellent with stearates, siliconates, waxes and fats. This can be explained by a surface coating using these substances. Although the thus treated thermal-insulation materials are hydrophobized on the surface thereof and repellent to liquid water, they absorb water vapour, in the form of air humidity. This leads to a deterioration in the insulation properties.

EP 1988228 A1 describes a press process to form hydrophobic, microporous thermal-insulation mouldings by addition of organosilanes during a mixing process. The resulting thermal-insulation mouldings are hydrophobized throughout. What can be considered to be a disadvantage of this process is that a press process to form stable sheets is possible only with great difficulty, especially when gaseous products arise during the hydrophobization.

WO 2013/013714 A1 discloses a process for producing silica-containing thermal-insulation mouldings hydrophobized throughout by treatment of corresponding hydrophilic mouldings with gaseous hydrophobization agents. Although such thermal-insulation articles exhibit good thermal-insulating properties, they have the disadvantage that they can no longer be efficiently after-treated with the water-based coating agents.

It is therefore an object to provide a thermal-insulation sheet hydrophobized throughout which exhibits a good adhesion with polar, typically water-based materials, such as, for example, water-based paints, coating agents and the like. It is a further object to provide a technically simple-to-perform and economical process for producing such sheets.

The invention provides a silicon dioxide-containing thermal-insulation sheet hydrophobized throughout, in which the compressive stress at fracture measured on the sheet surface is higher than the compressive stress at fracture measured on the sectional surface in the middle cross section of the sheet parallel to the sheet surface, at, in each case, the same penetration depths of the measurement probe in the test specimen.

The chemical and mechanical material properties on the surface and in the core of the sheet according to the invention can greatly differ from one another. In order to be able to compare these with one another in a comparable manner, the properties of the outer sheet surface (FIG. 2, 1) were compared with those measured on the sectional surface in the middle cross section of the sheet parallel to the sheet surface (FIG. 2, 2). In this connection, the outer sheet surface can be directly analysed without further preparation, as described in detail below. In order to generate an inner sectional surface, the sheet to be analysed can be cut in the middle parallel to the outer surface (FIG. 2), and so the resulting sheet has a halved thickness and a new outer surface (FIG. 2, 2) which imparts the properties of the core of the original sheet.

The value for compressive stress at fracture, as additionally described below, allows the surface hardness of the tested sheets to be compared with one another. Such a measurement of compressive stress is done on the basis of DIN EN 826:2013 “Thermal insulating products for building applications—Determination of compressive behaviour” and ISO 6603-2:2000 “Plastics—Determination of puncture impact behaviour of rigid plastics—Part 2: Instrumented impact testing”. The standard is to determine the compressive stress of sheets at 10% strain in accordance with DIN EN 826:2013. By contrast, in accordance with ISO 6603-2:2000, relatively hard plastics articles are broken through with a sharp test probe with use of a relatively high impact energy. Since the sheets according to the invention typically have a mechanically harder surface than the sheet core, which, however, is in absolute terms much softer than the plastics surface, it was found to be appropriate to apply a new test method, which advantageously combines technical teaching of DIN EN 826:2013 and ISO 6603-2:2000, for determining the surface hardness of the sheets according to the invention. This combined method will be described in detail below.

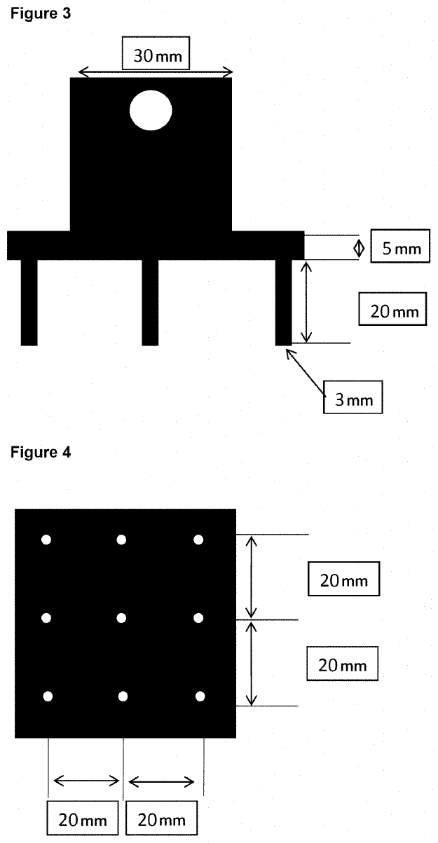

The horizontally placed sheet to be analysed with square area having an edge length of at least 100 mm and a thickness of at least 10 mm was, by means of a press centred above the sample and having a punch (FIG. 3: side view; FIG. 4: view from the bottom), pressed from top to bottom. The punch has 9 identical round measurement probes having, in each case, a 3 mm diameter. This punch is used to press into the sample surface at a feed rate of 4 mm/min; at the same time, the resulting compressive force (in N) and the penetration depth (in mm) of the test probes in the surface to be analysed are determined. The measured compressive force at a determined penetration depth of the measurement probe in the surface to be analysed can be converted to compressive stress via the area of the measurement probe:

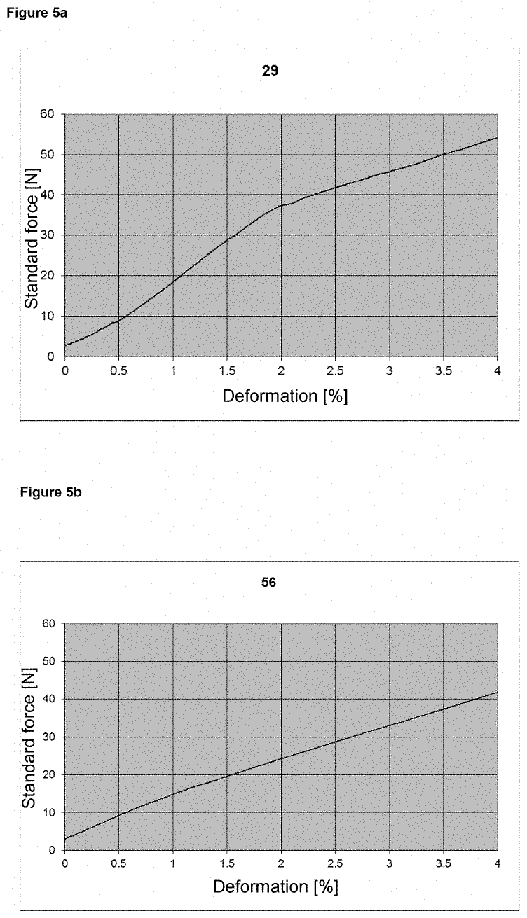

σₙ=Fₙ/A,

where a is a compressive stress in Pa at determined penetration depth n (in mm), Fₙ is a measured compressive force in N; A is a cross-sectional area of the measurement probe in m² (in the present case A=9*7.07 mm²=63.6*10⁻⁸ m²). On the basis of this measurement, it is possible to create a compressive stress-penetration depth curve which is characteristic of the surface in question. If the thus obtained compressive stress-penetration depth curve (standard force [N]−deformation [%]) for the outer sheet surface of the sheet according to the invention is viewed, it is possible to easily identify a kink (abrupt change in the slope) (FIG. 5, a), which corresponds to the fracture of the hard surface under the measurement probe. By contrast, if the core of the sheet is analysed in the same way at its middle sectional surface, no kink is viewed in the compressive stress-penetration depth curve profile (FIG. 5, b). If these two curves are then compared with each other, it is possible to relate the compressive stress at fracture on the outer surface of the sheet to the corresponding compressive stress at fracture measured on the inner surface at the same penetration depth. This gives rise to a ratio (A/I) which imparts a relative hardness of the outer surface (A) to hardness of the core, “inner” surface (I). This ratio multiplied by 100 gives a corresponding ratio of the outer hardness to inner hardness as a percentage. The value of 100% corresponds to the same hardness of the material on the outer surface and in the interior of the sheet. The value of above 100% corresponds to a harder outer surface than in the core. If, now, 100 is subtracted from this ratio as percentages, what is obtained is a difference between the outer hardness and inner hardness as a percentage:

Δ(A/I),%=(100*A/I)−100

The compressive stress at fracture measured on the sheet surface of the sheet according to the invention is higher than the compressive stress at fracture measured on the sectional surface in the middle cross section of the sheet parallel to the sheet surface at, in each case, the same penetration depths of the measurement probe in the test specimen.

Preferably, the compressive stress at fracture measured on the sheet surface is higher by at least 20%, particularly preferably by at least 30%, than the compressive stress at fracture measured on the sectional surface in the middle cross section of the sheet parallel to the sheet surface, at, in each case, the same penetration depths of the measurement probe in the test specimen.

The thermal-insulation sheet of the present invention can contain opacifiers, fibres and/or fine inorganic additives.

For reinforcement, i.e. for mechanical reinforcement, fibres are concomitantly used. Said fibres can be of inorganic or organic origin and can be up to 12% by weight of the mixture. Examples of inorganic fibres that can be used are glass wool, rock wool, basalt fibres, slag wool and ceramic fibres, these deriving from melts comprising aluminium and/or silicon dioxide, and also from other inorganic metal oxides. Examples of pure silicon dioxide fibres are silica fibres. Examples of organic fibres which can be used are cellulose fibres, textile fibres and synthetic fibres. The diameter of the fibres is preferably 1-12 μm, particularly preferably 6-9 μm, and the length is preferably 1-25 mm, particularly preferably 3-10 mm.

The thermal-insulation sheet of the present invention can contain at least one IR opacifier. Such an IR opacifier reduces the infrared transmittance of a thermal-insulation material and thus minimizes the heat transfer due to radiation. Preferably, the IR opacifier is selected from the group consisting of silicon carbide, titanium dioxide, zirconium dioxide, ilmenites, iron titanates, iron oxides, zirconium silicates, manganese oxides, graphites, carbon blacks and mixtures thereof. It is preferable that these opacifiers have a maximum at from 1.5 to 10 μm in the infrared region of the spectrum. The particle size of the opacifiers is generally between 0.1 and 25 μm.

The thermal-insulation sheet according to the invention contains silicon dioxide. This is preferably present in the form of a fumed silica and/or an aerogel.

Silicon dioxide aerogels are produced by specific drying methods from aqueous silicon dioxide gels. They similarly have a very high degree of pore structure and are therefore highly effective insulating materials.

Fumed silicas are produced via flame hydrolysis of volatile silicon compounds such as organic and inorganic chlorosilanes. This process uses a flame formed via combustion of hydrogen and of an oxygen-containing gas for the reaction of a hydrolysable silicon halide in the form of vapour or in gaseous form. The combustion flame here provides water for the hydrolysis of the silicon halide, and sufficient heat for the hydrolysis reaction. Silica produced in this way is termed fumed silica. This process initially forms primary particles which are virtually free of interior pores. These primary particles then fuse during the process via so-called “sinter necks” to afford aggregates. By virtue of this structure, fumed silica is an ideal thermal-insulation material, since the aggregate structure provides adequate mechanical stability, minimizes heat transfer due to conductivity in the solid by way of the “sinter necks”, and produces sufficiently high porosity.

Furthermore, inorganic filler materials can be added to the thermal-insulation sheet according to the invention. It is possible to use various synthetically produced modifications of silicon dioxide, such as precipitated silicas, arc silicas, SiO₂-containing fly ash produced via oxidation reactions of volatile silicon monoxide during electrochemical production of silicon or ferrosilicon. Also possible are silicas produced via leaching of silicates such as calcium silicate, magnesium silicate and mixed silicates such as olivine with acids. It is moreover possible to use naturally occurring SiO₂-containing compounds such as diatomaceous earths and kieselguhrs. It is likewise possible to add thermally expanded minerals such as perlites and vermiculites, and fine-particle metal oxides such as aluminium oxide, titanium dioxide, iron oxide.

The thermal-insulation sheet according to the invention contains preferably at least 50% by weight, particularly preferably at least 60% by weight, very particularly preferably at least 70% by weight, of silicon dioxide and preferably at least 5% by weight, particularly preferably at least 10% by weight, very particularly preferably at least 15% by weight, of an IR opacifier.

In a particular embodiment of the invention, the thermal-insulation sheet according to the invention contains 45-95% by weight, preferably 55-90% by weight, of fumed silicon dioxide and/or silicon dioxide aerogel, 5-20% by weight, preferably 7-15% by weight, of opacifier, 5-35% by weight, preferably 10-30% by weight, of fine inorganic additives and 0-12% by weight, preferably 1-5% by weight, of fibres.

The thermal-insulation sheet of the present invention can contain from 0.05 to 15% by weight of carbon; the carbon content is preferably from 0.1 to 10% by weight, particularly preferably from 0.5 to 8% by weight. In this connection, the carbon content can be used as an index of the extent of surface treatment.

For example, the carbon content can be determined via carrier-gas hot-extraction analysis, for example by means of the model CS 244 or CS 600 instruments from LECO. This involves weighing sample material in a ceramic crucible, providing it with combustion additives and heating it in an induction oven under an oxygen stream. This oxidizes the carbon present to CO₂. This amount of gas is quantified by means of infrared detectors. The other test methods suitable for carbon determination can be used too.

The thermal-insulation sheet according to the invention preferably has a thickness from 5 to 500 mm, particularly preferably from 10 to 300 mm, very particularly preferably from 20 to 200 mm.

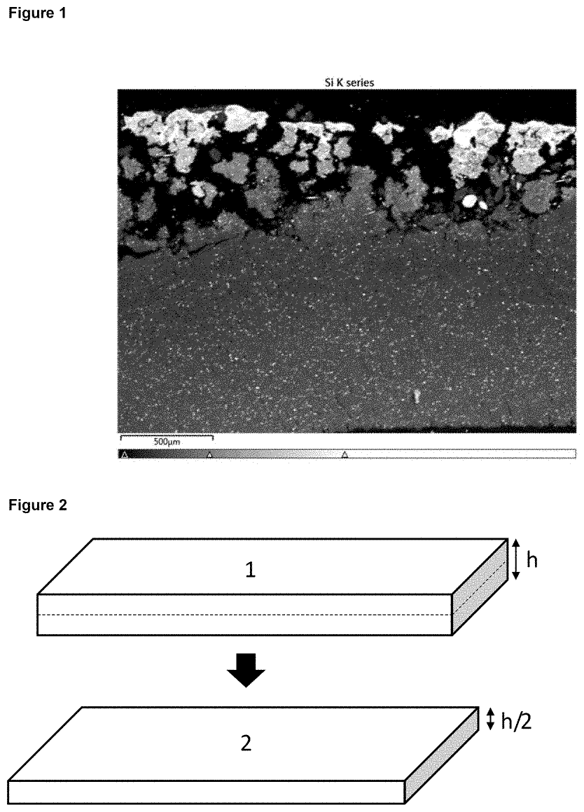

The thermal-insulation sheet of the present invention is preferably surrounded by a coating which has a higher material density than the core of the sheet. Such a coating can, for example, be viewed and analysed on the cross section of the thermal-insulation sheet according to the invention by means of SEM-EDX analysis (energy-dispersive X-ray spectroscopy), as depicted in FIG. 1. A sheet coating appearing lighter than the core of the sheet indicates a higher material density in the analysis of the Si K series. The average thickness of such a coating is preferably from 100 to 2000 μm, particularly preferably from 200 to 1000 μm.

The surface of the thermal-insulation sheet according to the invention preferably has a relatively high roughness, as is evident from FIG. 1. The roughness of the sheet surface can be analysed in accordance with DIN EN ISO 4287; in this connection, the thermal-insulation sheet according to the invention preferably has a groove depth Rᵥ from 100 to 500 μm, particularly preferably from 150 to 400 μm, and an average interval of the grooves Rₛₘ preferably from 100 to 5000 μm, particularly preferably from 200 to 4000 μm, very particularly preferably from 300 to 3000 μm.

The thermal-insulation sheet according to the invention is hydrophobized throughout, i.e. both the core of the sheet and the surface thereof have, for example, been treated with a hydrophobization agent such that the sheet has hydrophobic properties both inside and outside.

The terms “hydrophobic” and “hydrophobized” in the context of the present invention are equivalent and relate to the particles having a low affinity for polar media such as water. The hydrophilic particles, by contrast, have a high affinity for polar media such as water. The hydrophobicity of the hydrophobic materials can typically be achieved by the application of appropriate nonpolar groups to the silica surface. The extent of the hydrophobicity of a pulverulent hydrophobic silica can be determined via parameters including its methanol wettability, as described in detail, for example, in WO2011/076518 A1, pages 5-6. In pure water, a hydrophobic silica separates completely from the water and floats on the surface thereof without being wetted with the solvent. In pure methanol, by contrast, a hydrophobic silica is distributed throughout the solvent volume; complete wetting takes place. In the measurement of methanol wettability, a maximum methanol content at which there is still no wetting of the silica is determined in a methanol/water test mixture, meaning that 100% of the silica used remains separate from the test mixture after contact with the test mixture, in unwetted form. This methanol content in the methanol/water mixture in % by weight is called methanol wettability. The higher the level of such methanol wettability, the more hydrophobic the silica. The lower the methanol wettability, the lower the hydrophobicity and the higher the hydrophilicity of the material.

The above-described methanol wettability can also be used for the qualitative and also quantitative characterization of the hydrophobicity of a sheet surface. This involves using a drop of the methanol/water mixture to treat a horizontally placed surface to be analysed.

In the course of this, the drop can roll off from the surface, i.e. remain on the surface in the form of a drop with a contact angle of about 90 to 180° or wet it, i.e. spread on the surface and form a contact angle of less than 90° with the surface, or be entirely absorbed into the material of the sheet. A test surface can be treated with a series of methanol/water mixtures having different concentrations. The maximum content of methanol in a methanol/water test mixture at which there is still no wetting of the surface is called methanol wettability of the surface, OB_{MeOH}, in the context of the present invention.

The thermal-insulation sheet of the present invention preferably has a sheet surface with a methanol wettability of at least 5% by weight, particularly preferably from 10 to 90% by weight, very particularly preferably from 20 to 80% by weight, of methanol in methanol/water mixture.

The sectional surface in the middle cross section of the thermal-insulation sheet according to the invention parallel to the sheet surface preferably has a methanol wettability of at least 5% by weight, particularly preferably from 10 to 90% by weight, very particularly preferably from 20 to 80% by weight, of methanol in methanol/water mixture.

The thermal-insulation sheet according to the invention has a good adhesion with polar coating agents, especially water-based materials. The thermal-insulation sheet of the present invention can, for example, be used for the treatment thereof with a water-based paint, an aqueous coating agent, adhesive and/or an aqueous cement-, render- or mortar-containing formulation.

The thermal-insulation sheet according to the invention, in an uncoated or additionally coated form, can particularly preferably be used for external insulation of buildings.

The invention further provides a process for producing a silicon dioxide-containing thermal-insulation sheet hydrophobized throughout, comprising the following steps:

a) treating a hydrophilic silicon dioxide-containing sheet with a silicon-containing surface-modification agent;

b) drying and/or thermally treating the sheet treated with surface-modification agent to form a coated sheet;

c) hydrophobizing the coated sheet with a hydrophobization agent.

The silicon-containing surface-modification agent used in step a) of the process according to the invention is preferably selected from the group consisting of silica sol, siloxane oligomers, silicates and water glass. Said surface-modification agent can be used in step a) without solvent or particularly preferably as a solution. Particularly preferably, a solution containing at least one surface-modification agent and at least one solvent selected from the group consisting of water, alcohols, ethers and esters is used in step a). Very particularly preferably, an aqueous solution of the surface-modification agent is used in this step of the process according to the invention.

In a particular embodiment of the invention, the silicon-containing surface-modification agent can be applied together with a fibrous material to the sheet surface in step a) of the process according to the invention. Alternatively, such a fibrous material can be applied after the treatment with the surface-modification agent. Particularly preferably, a top layer consisting of fibres is applied to the sheet treated in step a) with a surface-modification agent. This can, for example, be a non-woven or a porous film. The above-described fibrous materials, additionally referred to as fibres for simplification, can be of inorganic or organic origin. Examples of inorganic fibrous materials that can be used are glass wool, rock wool, basalt fibres, slag wool and ceramic fibres, these deriving from melts comprising aluminium and/or silicon dioxide, and also from other inorganic metal oxides. Examples of pure silicon dioxide fibres are silica fibres. Examples of organic fibres which can be used are cellulose fibres, textile fibres and synthetic fibres. The diameter of the fibres is preferably 1-200 μm, particularly preferably 5-100 μm, and the basis weight is preferably 10-1000 g/m², particularly preferably 15-500 g/m².

The relative amount of the surface-modification agent used can, firstly, determine the thickness of the coating and thus the mechanical and chemical properties of the surface and, secondly, substantially influence the total costs of the sheets produced. Particularly preferably, sufficient surface-modification agent is used in step a) of the process according to the invention such that the layer generated in step b) has an average thickness from 100 to 2000 μm. The average layer thickness can, for example, be visually determined from an SEM-EDX image, as the mean of at least 100 randomly selected points on the surface.

At least one organosilane selected from the group consisting of Rₙ—Si—X₄₋ₙ, R₃Si—Y—SiR₃, RₙSiₙOₙ, (CH₃)₃—Si—(O—Si(CH₃)₂)ₙ—OH, HO—Si(CH₃)₂—(O—Si(CH₃)₂)ₙ—OH, where n=1-8; R═—H, —CH₃, —C₂H₅; X═—Cl, —Br; —OCH₃, —OC₂H₅, —OC₃H₈, Y═NH, O, can be used as hydrophobization agent in step c) of the process according to the invention.

Preference is given to selecting a hydrophobization agent from the group consisting of CH₃SiCl₃, (CH₃)₂SiCl₂, (CH₃)₃SiCl, C₂H₅SiCl₃, (C₂H₅)₂SiCl₂, (C₂H₅)₃SiCl, C₃H₈SiCl₃, CH₃Si(OCH₃)₃, (CH₃)₂Si(OCH₃)₂, (CH₃)₃SiOCH₃, C₂H₅Si(OCH₃)₃, (C₂H₅)₂Si(OCH₃)₂, (C₂H₅)₃SiOCH₃, C₈H₁₅Si(OC₂H₅)₃, C₈H₁₅Si(OCH₃)₃, (H₃C)₃SiNHSi(CH₃)₃ (CH₃)₃SiOSi(CH₃)₃, (CH₃)₈Si₄O₄[octamethyltetracyclosiloxane], (CH₃)₆Si₃O₃ [hexamethyltricyclosiloxane] and (CH₃)₃Si(OSi(CH₃)₂)₄OH [low-molecular-weight polysiloxanol] and mixtures thereof. Particular preference is given to using (CH₃)₃SiCl, (CH₃)₂SiCl₂, CH₃SiCl₃, (CH₃)₃SiNHSi(CH₃)₃ and (CH₃)₈Si₄O₄.

Particular preference is given in this connection to using a hydrophobization agent which is in gaseous form at a temperature for carrying out step c). Very particular preference is given to using as hydrophobization agent compounds which are liquid at 25° C. and which have at least one alkyl group and a boiling point at standard pressure of less than 200° C.

The process according to the invention can also be carried out by using polar substances during or after the introduction of the hydrophobization agent in step c). Preferably, this can be water, alcohols and/or hydrogen halides.

Individual steps of the process according to the invention can be carried out once only or two or more times in succession. For example, steps a) and b) of the process according to the invention can be carried out two or more times in succession in an alternating manner before step c) is carried out. On the other hand, step a) and/or b) can additionally be carried out at least once after step c).

It may be advantageous for the temperature to be set from 20° C. to 300° C. during the process according to the invention. As a result, it is possible to control the treatment time. Depending on the nature of the surface-modification agent and hydrophobization agent used, it may be particularly advantageous to choose a temperature from 50 to 200° C.

After completion of the treatment with hydrophobization agent in step c) of the process according to the invention, any excess organosilanes and reaction products can be removed from the now hydrophobic thermal-insulation sheet by heating.

### EXAMPLES

### Analysis of the Outer Surface and Core Properties

The outer sheet surface (FIG. 2, 1) was directly analysed without further preparation, as described below. By contrast, the chemical and mechanical properties of the sheet core were determined on a middle cross-sectional surface of the sheet (FIG. 2, 2). For this purpose, the sheets to be analysed were cut in the middle parallel to the outer surface (FIG. 2), and so the resulting sheet has a halved thickness and a new outer surface (FIG. 2, 2) which imparts properties of the core of the original sheet.

### Determination of the Compressive Stress at Fracture and Δ(A/I), %

The horizontally placed sheet to be analysed with square area having an edge length of at least 100 mm and a thickness of at least 10 mm was, by means of a press centred above the sample and having a punch (FIG. 3: side view; FIG. 4: view from the bottom), pressed from top to bottom. The punch has 9 identical round measurement probes having, in each case, a 3 mm diameter. This punch is used to press into the sample surface at a feed rate of 4 mm/min; at the same time, the resulting compressive force (in N) and the penetration depth (in mm) of the test probes in the surface to be analysed are determined. The measured compressive force at a determined penetration depth of the measurement probe in the surface to be analysed can be converted to compressive stress via the area of the measurement probe:

σₙ=Fₙ/A,

where σ is a compressive stress in Pa at determined penetration depth n (in mm), Fₙ is a measured compressive force in N; A is a cross-sectional area of the measurement probe in m² (in the present case A=9*7.07 mm²=63.6*10⁻⁶ m²). On the basis of this measurement, it is possible to create a compressive stress-penetration depth curve which is characteristic of the surface in question. If the thus obtained compressive stress-penetration depth curve (standard force [N]−deformation [%]) for the outer sheet surface of the sheet according to the invention is viewed, it is possible to easily identify a kink (abrupt change in the slope) (FIG. 5, a), which corresponds to the fracture of the hard surface under the measurement probe. By contrast, if the core of the sheet is analysed in the same way at its middle sectional surface, no kink is viewed in the compressive stress-penetration depth curve profile (FIG. 5, b). If these two curves are then compared with each other, it is possible to relate the compressive stress at fracture on the outer surface of the sheet to the corresponding compressive stress at fracture measured on the inner surface at the same penetration depth. This gives rise to a ratio which imparts a relative hardness of the outer surface to hardness of the core. This ratio multiplied by 100 gives a corresponding ratio of the outer surface hardness to inner surface hardness as a percentage. If 100 is subtracted from this ratio as percentages, what is obtained is a difference between the outer surface hardness and inner surface hardness as a percentage, which difference is listed in Table 1:

Δ(A/I),%=(100*A/I)−100

Measurement of the Roughness, Rᵥ, Rₛₘ

The roughness of the surface was determined in accordance with DIN EN ISO 4287; this involved evaluating the indices groove depth Rᵥ and groove interval Rₛₘ. The instrument used and its setting for this purpose is described below:

| Parameter | Value | |
|---|---|---|
| Measurement instrument | Alicona InfiniteFocus | |
| Measurement principle | Focus variation | |
| Objective (magnification) | 5x | |
| Vertical resolution | 2 | μm |
| Lateral resolution | 5 | μm |
| Coaxial illumination | | |
| (light source: 1.0) | 1.25 | ms |
| Contrast | 2.3 | |
| Light amplification | 1.0 | |
| Ring light | on (100%) | |
| Data post-processing | Elimination of outliers (0.1) | |
| Measurement distance ln | 40 | mm |
| Cut-off wavelength λc | 8 | mm |

### Determination of the Surface Hydrophobicity, OB_{MEOH}, %

The horizontally placed surface to be analysed was treated with a drop of the water or methanol/water mixture at at least 5 different points. A drop was positioned by means of a suitable pipette. The drops deposited on the surface were visually assessed after a standing time of 1 hour. In the course of this, the drops as a whole could remain on the surface with a contact angle of about 90 to 180° or wet it, i.e. spread on the surface and form a contact angle of less than 90° with the surface, or be entirely absorbed into the material of the sheet. The corresponding behaviour of the majority of drops on the surface was evaluated as the first qualitative result. A test series with the drops with different methanol/water mixtures yielded quantitative information about the extent of the surface hydrophobicity. The maximum content of methanol in % by weight in a methanol/water test mixture at which there is still no wetting of the surface is called methanol wettability of the surface OB_{MEOH}, %.

### Thermal Conductivity

The thermal conductivity of the sheets was determined at room temperature using a guarded hot plate in accordance with EN 12667:2001.

### Coating of the Produced Sheets

The sheets were applied with a water-based silicate paint (Bauhaus, “Swingcolor” silicate paint, silicate indoor paint, matt/white) using a brush by painting onto the sheet surface; the paint coat was then dried at room temperature. The adhesion of the paint on the surface was qualitatively assessed both during the application and also after the drying. All the sheets exhibiting a good adhesion of the silicate paint (Examples 1-6) were also able to be coated with cement mortar with great success. In this connection, the latter was directly painted onto the hardened sheet after mixing with water to yield a pasty form using a toothed spatula.

### Comparative Example 1

A desiccator heated to 100° C. is initially charged with a microporous thermal-insulation material panel having dimensions of 250×250×20 mm, an apparent density of 170 kg/m³, and a composition of 80.0% by weight of fumed silica having a BET surface area of 200 m²/g, 16.0% by weight of silicon carbide and 4.0% by weight of glass fibres (diameter=9 μm; length=6 mm). The pressure in the desiccator is reduced to 15 mbar with the aid of a water jet pump. Sufficient vaporous hexamethyldisilazane is then slowly introduced into the desiccator to raise the pressure to 300 mbar. After a standing time of 1 hour under a silane atmosphere, the hydrophobized sheet is cooled and vented.

The sheet thus produced was hydrophobic throughout, had the same hardness for the outer surface and the core and a relatively low roughness for the surface (Table 1). Said sheet exhibited a very poor adhesion of the paint coat both during the application of the silicate paint and after the drying thereof.

### Comparative Example 2

A hydrophobized sheet produced as described in Comparative Example 1 was sprayed with water (300 g/m²) at 25° C. using an airless spray gun, and then dried at about 25° C. in a fume cupboard.

The sheet thus produced was hydrophobic throughout, had approximately the same hardness for the outer surface and the core and a roughness for the surface that was somewhat higher than in Comparative Example 1 (Table 1). Said sheet exhibited a very poor adhesion of the paint coat both during the application of the silicate paint and after the drying thereof.

### Comparative Example 3

A microporous thermal-insulation material panel having dimensions of 250×250×20 mm, an apparent density of 170 kg/m³, and a composition of 80.0% by weight of fumed silica having a BET surface area of 200 m²/g, 16.0% by weight of silicon carbide and 4.0% by weight of glass fibres (diameter=9 μm; length=6 mm) was coated five times in succession with 100 g/m² silica sol IDISIL® 1530 (30% by weight of SiO₂ in water, particle size 15 nm, Evonik Resource Efficiency GmbH) and dried in each case. Thereafter, the sheet was hydrophobized with gaseous hexamethyldisilazane in the desiccator as described in Comparative Example 1.

The sheet thus produced was not hydrophobic throughout. The outer surface was hydrophobic, whereas the core of the sheet was not. The outer surface was harder by 80% than the core of the sheet (Table 1). The roughness of the surface was not determined, but the sheet appeared visually very smooth. Said sheet exhibited a poor adhesion of the paint coat both during the application of the silicate paint and after the drying thereof.

### Example 1

A microporous thermal-insulation material panel having dimensions of 250×250×50 mm, an apparent density of 170 kg/m³, and a composition of 80.0% by weight of fumed silica having a BET surface area of 200 m²/g, 16.0% by weight of silicon carbide and 4.0% by weight of glass fibres (diameter=9 μm; length=6 mm) was sprayed with 300 g/m² Hydrosil® 2627 (water-based amino-functional oligomeric siloxane, Evonik Resource Efficiency GmbH) at 25° C. using an airless spray gun, and then dried at about 25° C. in a fume cupboard. Thereafter, the sheet was hydrophobized with gaseous hexamethyldisilazane in the desiccator as described in Comparative Example 1.

The sheet thus produced was hydrophobic throughout. The outer surface was harder by 75% than the core of the sheet (Table 1). Said sheet exhibited a good adhesion of the paint coat both during the application of the silicate paint and after the drying thereof.

### Example 2

The sheet was produced as in Example 1, the only difference being that Hydrosil® 1153 (water-based amino-functional oligomeric siloxane, Evonik Resource Efficiency GmbH) was used for the coating of the hydrophilic sheet.

The sheet thus produced was hydrophobic throughout. The outer surface was harder by 40% than the core of the sheet (Table 1). Said sheet exhibited a good adhesion of the paint coat both during the application of the silicate paint and after the drying thereof.

### Example 3

The sheet was produced as in Example 1, the only difference being that silica sol IDISIL® 1530 (30% by weight of SiO₂ in water, particle size 15 nm, Evonik Resource Efficiency GmbH) was used for the coating of the hydrophilic sheet.

The sheet thus produced was hydrophobic throughout. The outer surface was harder by 30% than the core of the sheet (Table 1). Said sheet exhibited a good adhesion of the paint coat both during the application of the silicate paint and after the drying thereof.

### Example 4

The sheet was produced as in Example 1, the only difference being that Protectosil® WS 808 (water-based propyl siliconate/silicate, Evonik Resource Efficiency GmbH) was used for the coating of the hydrophilic sheet, and afterwards a glass web having a density per unit area of 30 g/m2 and a web thickness of 0.3 mm was applied to the coated surface and the coating was then dried.

The sheet thus produced was hydrophobic throughout. The outer surface was harder by 120% than the core of the sheet (Table 1). Said sheet exhibited a good adhesion of the paint coat both during the application of the silicate paint and after the drying thereof.

### Example 6

A hexamethylsilazane-hydrophobized sheet produced as in Comparative Example 1 was sprayed with 300 g/m² Dynasilan® AR (ethanol-based silica ester—hybrid binder with additionally incorporated colloidal SiO₂ particles, Evonik Resource Efficiency GmbH) at 25° C. using an airless spray gun, and then dried at about 25° C. in a fume cupboard.

The sheet thus produced was hydrophobic throughout. The outer surface was harder by 50% than the core of the sheet (Table 1). Said sheet exhibited a good adhesion of the paint coat during the application of the silicate paint.

All the sheets according to the invention (Examples 1-6) had a thermal conductivity of less than 20 mW/(m*K).

TABLE 1

| | | | | Groove depth Rᵥ | Groove interval | |
|---|---|---|---|---|---|---|
| | | | | in accordance with | in accordance with | Adhesion of |
| | | Inner surface | | DIN EN ISO 4287 | DIN EN ISO 4287 Rₛₘ | the aqueous |
| | Outer surface | hydrophobicity/ | Outer/inner | (range/number | (range/number | silicate paint |
| | hydrophobicity/ | wetting | hardness, | of measurements), | of measurements), | during |
| | OB_{MEOH}, % | with water | Δ(A/I), % | μm | μm | application |
| Comparative | yes/60 | yes | 0 | 70-200/14 | 400-2000/14 | poor |
| Example 1 | | | | | | |
| Comparative | yes/60 | yes | 0 | 350-520/2 | 500-710/2 | poor |
| Example 2 | | | | | | |
| Comparative | yes/n.d. | no | 80 | n.d. | n.d. | poor |
| Example 3 | | | | | | |
| Example 1 | yes/45 | yes | 75 | 290-320/2 | 415-460/2 | good |
| Example 2 | yes/30 | yes | 40 | 260-370/2 | 550-775/2 | good |
| Example 3 | yes/60-65 | yes | 30 | 114-280/3 | 1800-2400/3 | good |
| Example 4 | yes/60 | yes | 55 | 160-200/2 | 750-1050/2 | good |
| Example 5 | yes/60-65 | yes | 120 | n.d. | n.d. | good |
| Example 6 | yes/55 | yes | 50 | 240-310/2 | 370-470/2 | good |

n.d. = not determinable

1-17. (canceled)

18. A silicon dioxide-containing thermal-insulation sheet hydrophobized throughout, wherein the compressive stress at fracture measured on the sheet surface is higher than the compressive stress at fracture measured on the sectional surface in the middle cross section of the sheet parallel to the sheet surface, at, in each case, the same penetration depths of the measurement probe in the test specimen.

19. The silicon dioxide-containing thermal-insulation sheet of claim 18, wherein the sheet comprises at least 50% by weight silicon dioxide and at least 5% by weight IR opacifier.

20. The silicon dioxide-containing thermal-insulation sheet of claim 18, wherein the IR opacifier is selected from the group consisting of: silicon carbide, titanium dioxide; zirconium dioxide; ilmenites; iron titanates; iron oxides; zirconium silicates; manganese oxides; graphites; carbon blacks; and mixtures thereof.

21. The silicon dioxide-containing thermal-insulation sheet of claim 18, wherein the sheet comprises from 0.1 to 10% by weight of carbon.

22. The silicon dioxide-containing thermal-insulation sheet of claim 18, wherein the compressive stress at fracture measured on the sheet surface is higher by at least 20% than the compressive stress at fracture measured on the sectional surface in the middle cross section of the sheet parallel to the sheet surface, at, in each case, the same penetration depths of the measurement probe in the test specimen.

23. The silicon dioxide-containing thermal-insulation sheet of claim 18, wherein the sheet has a thickness from 5 to 500 mm.

24. The silicon dioxide-containing thermal-insulation sheet of claim 18, wherein the sheet is surrounded by a coating which has a higher material density than the core of the sheet.

25. The silicon dioxide-containing thermal-insulation sheet of claim 18, wherein the roughness of the sheet surface measured in accordance with DIN EN ISO 4287 has a groove depth Rᵥ from 100 to 500 μm and an average interval of the grooves Rₛₘ from 100 to 5000 μm.

26. The silicon dioxide-containing thermal-insulation sheet of claim 18, wherein both the sheet surface and the sectional surface in the middle cross section of the sheet parallel to the sheet surface have a methanol wettability of at least 5% by weight of methanol.

27. The silicon dioxide-containing thermal-insulation sheet of claim 19, wherein the IR opacifier is selected from the group consisting of: silicon carbide, titanium dioxide; zirconium dioxide; ilmenites; iron titanates; iron oxides; zirconium silicates; manganese oxides; graphites; carbon blacks; and mixtures thereof.

28. The silicon dioxide-containing thermal-insulation sheet of claim 27, wherein the sheet comprises from 0.1 to 10% by weight of carbon and the sheet has a thickness from 5 to 500 mm.

29. The silicon dioxide-containing thermal-insulation sheet of claim 28, wherein the roughness of the sheet surface measured in accordance with DIN EN ISO 4287 has a groove depth Rᵥ from 100 to 500 m and an average interval of the grooves Rₛₘ from 100 to 5000 m and wherein the sheet is surrounded by a coating which has a higher material density than the core of the sheet.

30. A process for producing a silicon dioxide-containing thermal-insulation sheet hydrophobized throughout, comprising:
a) treating a hydrophilic silicon dioxide-containing sheet with a silicon-containing surface-modification agent;
b) drying and/or thermally treating the sheet treated with surface-modification agent to form a coated sheet; and
c) hydrophobizing the coated sheet with a hydrophobization agent.

31. The process of claim 30, wherein the silicon-containing surface-modification agent is selected from the group consisting of: silica sol; siloxane oligomers; silicates; and water glass.

32. The process of claim 30, wherein a solution containing at least one surface-modification agent and at least one solvent selected from the group consisting of: water; alcohols, ethers and esters is used in step a).

33. The process of claim 30, wherein sufficient surface-modification agent is used in step a) such that the layer generated in step b) has an average thickness from 100 to 2000 μm.

34. The process of claim 30, wherein at least one organosilane selected from the group consisting of: Rₙ—Si—X₄₋ₙ; R₃Si—Y—SiR₃; RₙSiₙOₙ; (CH₃)₃—Si—(O—Si(CH₃)₂)ₙ—OH; HO—Si(CH₃)₂—(O—Si(CH₃)₂)ₙ—OH; where n=1-8; R═—H, —CH₃, —C₂H₅; X═—Cl, —Br; —OCH₃, —OC₂H₅, —OC₃H, Y═NH, O, is used as hydrophobization agent in step c).

35. The process of claim 30, wherein steps a) and b) are carried out two or more times in succession in an alternating manner before step c) is carried out.

36. The process of claim 30, wherein step a) and/or b) is additionally carried out at least once after step c).

37. The thermal-insulation sheet of claim 18, wherein said sheet is treated with a water-based paint, an aqueous coating agent, adhesive and/or an aqueous cement-, render- or mortar-containing formulation.
